(19) United States
(12) Patent Application Publication
(10) Pub. No.: US 2004/0047013 A1
(43) Pub. Date: Mar. 11, 2004

(54) Holographic marketing method and system for consumer products in a retail environment

(76) Inventors: Heng Cai, Yardley, PA (US); Marian Nicusor Holerca, Highland Park, NJ (US); Evangelia Arvanitidou, Princeton, NJ (US); Rosemary Miano, Martinsville, NJ (US); Thomas Mintel, Rahway, NJ (US); Van Canady, Princeton, NJ (US)

Correspondence Address: HARNESS, DICKEY & PIERCE, P.L.C., P.O. BOX 828, BLOOMFIELD HILLS, MI, 48303, US

(21) Appl. No.: 10/236,352

(22) Filed: Sep. 6, 2002

(51) Int. Cl. G02B 5/32; A47F 11/06

(52) U.S. Cl. 359/15; 40/427

(57) ABSTRACT

A method of inducing a sale of a product in a retail environment includes providing the product in a storage structure from which a potential purchaser may take physical possession of the product. A true hologram is provided to project a three-dimensional holographic image into a first space proximate to the storage structure to attract potential purchaser attention. The holographic image from the true hologram is used to communicate information about the product to the potential purchaser.

### FIELD OF THE INVENTION

The present invention generally relates to marketing systems and methods, and particularly relates to the use of true holograms in a retail environment. More particularly, the invention relates to a method and system that employs a three-dimensional (“3D”) holographic image generated by a true hologram to attract consumer attention to a displayed product, communicate information about the product, and to create an overall impression or experience that is conducive to purchasing the product.

### BACKGROUND OF THE INVENTION

Selling products in a retail environment (also referred to herein as “retail products”), such as personal care products, consumable products, grocery products, and the like, is extremely competitive. Manufacturers of such products will typically develop and offer numerous different configurations, formulations, flavors, colors, and packaging of their products, in an effort to appeal to broader market segments and, therefore, capture greater market share.

While such offered variety benefits the consumer—giving the consumer a choice and allowing the consumer to select products that best fit his or her needs—such variety comes at a cost. Consumers may become overwhelmed or confused, or may end up purchasing a product without appreciating that a different product would have been better suited. Marketing and distinguishing easily confused products such as antiperspirants, shampoos, hair care products, toothpaste, toothbrushes, mouth rinses, detergents, cleaning products for household use (including cleaning implements), dishwashing and dishwasher detergents, and hair care products which may require mixing before use, proves especially difficult. Many of these products in a given category are hard to differentiate because of similarity in packaging due to shape or color. For example, many antiperspirants are in oval packages with clear, pastel or white packaging even though there are a variety of choices such as sticks, gels, and soft solids, to name a few. To the retail merchant, such a variety of offered products requires shelf space, a scarce resource that the retail merchant must use with utmost selling efficiency. A product that sits unsold on the retailer's shelf is a product quickly discarded for better selling products. Product manufacturers understand this well, and strive to make their product packaging and display material as informative as possible.

For the product manufacturer, the challenge is this. In the typical retail environment where consumer products, such as personal care products, consumable products, grocery products, and the like are sold, the average consumer makes his or her purchasing decision in a short period of time. On study has found that the length of time that a shopper spends at the shelf looking for an antiperspirant/deodorant product is in the range of 52-69 seconds. They either select a product or leave without a product. Another study has found that shoppers make 40-60% of their buying decisions while standing in front of the shelf. That means that any in-store marketing material, packaging, or display information must preferably communicate the benefits of the product or some distinguishing feature in as short a time as possible and, preferably in less than 60 seconds (more preferably within 30 seconds). This becomes particularly hard to do, where the choices are many and where the difference among products are subtle or sophisticated. Imagine, for example, communicating in a period of 60 seconds or less, the differences among several different types of antiperspirant/deodorant products that may have different fragrances, product forms, specific benefits (aloe, vitamins), and applicator technology (stick, roll-on, gel) or offer other selling features, such as dries quickly or leaves no residue on clothing. Communicating these differences in a retail environment to the busy, time-crunched consumer is indeed a very challenging problem.

The present invention takes a fresh approach. Rather than rely solely on printed material, such as on product packaging or associated signage, the present invention utilizes a true hologram which generates a three-dimensional holographic image to attract the consumer's attention and provide the consumer with information about the product. As will be explained more fully herein, the invention employs a three-dimensional holographic image to produce a powerful visual experience. As more fully explained, the product manufacturer or advertiser carefully selects and adapts the content of the holographic image to convey a clear message about the product, how to use the product, and/or to communicate a characteristic or an experience associated with using the product at the point of sale (also called “point of purchase”).

### SUMMARY OF THE INVENTION

According to the present invention, a method of inducing a sale of a product in a retail environment includes providing the product in a storage structure from which a potential purchaser may take physical possession of the product. A true hologram is provided to project a three-dimensional holographic image into a space proximate to the storage structure to attract potential purchaser attention. The holographic image from the true hologram is used to communicate information about the product to the potential purchaser.

As will be more fully explained, the inventive method accomplishes several beneficial results. It attracts the consumer's attention by providing an eye-catching visual display. It very quickly and dynamically communicates product information to the consumer. This extremely important benefit is needed to match the short attention span of busy and sometimes confused retail shoppers. The method is versatile. By using animated holographic techniques, even moving features or moving metaphors for product features can be readily communicated. The inventive method provides an engaging experience. It helps hold the consumer's attention while making a purchasing decision, and provides useful information to aid the consumer in discriminating among product choices. When deployed at or near the point of purchase, the inventive method works up to the moment of product selection: (a) the consumer is much less likely to make a mistake and purchase the wrong product; or (b) the consumer may be persuaded to purchase the particular product displayed by the hologram.

Moreover, because the holographic image can be generated to be partially or fully into a space above or in front of the product display shelf, the holographic image preferably takes up no physical space on the retail shelf. The image can even be larger than the actual product size, for example, without concern for using up valuable physical space. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flowchart diagram depicting the method of the present invention;

FIG. 2 is a block diagram depicting an exemplary retail environment wherein the retail environment is a grocery store;

FIG. 3 is a perspective view of the present invention implemented in an aisle of a retail environment; and

FIG. 4 is a perspective view of the present invention implemented with a modular display for strategic placement in a retail environment.

### DETAILED DESCRIPTION OF THE PREFERRED EMBODIMENTS

The following description of the preferred embodiment(s) is merely exemplary in nature and is in no way intended to limit the invention, its application, or uses. In practicing the method of the present invention, a variety of different holographic technologies may be employed. Presently preferred are the technologies that produce three-dimensional, holographic images. The so-called true hologram, differs from the more commonly seen, mass produced holograms employed on credit cards to deter forgery. The true hologram produces the visual experience of looking at a three-dimensional object by creating a wavefront of light that produces the appearance of a three-dimensional image at least partially in front of the plane of the hologram plate used to produce it. The 3D holographic image is produced by constructive and destructive interference of the light rays that make up the wavefront.

There are several techniques for producing a 3D holographic image using a true hologram. A “transmission hologram” employs a hologram plate or film, containing the image to be generated, and a light source positioned behind the plate. The viewer stands on the side of the plate opposite the light source. The light passes through the plate. Viewing the holographic image from a transmission hologram is like looking into a brightly-lit room through a window. The image is seen as a three-dimensional image in the “room”. A second type of true hologram is a “reflection hologram”. A reflection hologram employs a hologram plate or film with a reflective layer, and a light source positioned on the same side of the plate as the viewer. Viewing the image from a reflection hologram is like looking at an object or image that is floating in space. The image may be located anywhere along the line of sight axis. The hologram plate can be configured so that the image appears to project fully in front of the plane of the hologram plate or fully in back of the plate. Alternatively, the hologram plate can be configured so that the image only partially projects in front of the plate or partially in back of the plate.

In most applications of the present invention in a retail environment, reflection hologram technology is presently preferred. Good results are obtained using a white light source, such as from a bright halogen lamp, positioned to cast light upon the hologram plate without obstruction or shadow. This may be done by placing the light directly in front of the holographic plate or to the side with a means for deflecting the light onto the holographic plate. Where the product feature or selling point involves a moving part, or where the feature is best exemplified by movement or a moving metaphor, the hologram plate may be configured to produce animated effects. This can be done by a variety of different techniques. One technique employs a “multiplex hologram” in which photographic images (or computer-generated images) are developed from several angles onto the same hologram plate or film. When the viewer moves from one vantage point to another, such as by moving slightly from side to side, the holographic image appears to move as different ones of the photographic images come into view. The flexing head of a bendable toothbrush could be demonstrated in this fashion. As the viewer moves from side to side, the projected holographic image of the toothbrush appears to flex back and forth. For the underarm category, a product can be shown to move across a black cloth to demonstrate no white residue.

Suitable equipment may be selected from a variety of sources including Krystal Holographics, Inc., New York, N.Y.; Dai Nippon Printing Co., Ltd., Japan; and Zebra Imaging, Inc., Austin, Tex. Of special interest as technology for producing high quality true holograms is available from Zebra Technologies, and is referred to as a “Zebra”. According to Zebra Technologies: A Zebra is, in essence, one large hologram made up of lots of small ones. The process starts with a digital image, which may be generated by a motion-controlled camera or computer graphics software. Like conventional holography, the Zebra process splits and recombines laser light, only the “object” sub-beam is directed through a sequence of digital images on a liquid-crystal screen rather than reflected off a real object. Each resulting exposure, about two millimeters square, is called a “hogel”—the full-color holographic building blocks of a finished Zebra image. In a fully-automated step-and-repeat fashion, hogels are then printed on a flat, square tile of polymer film, which needs no chemical processing. Each two-foot-square tile houses tens of thousands of unique hogels, and each tile can be butted up against another to form high-quality holographic images of unlimited size.

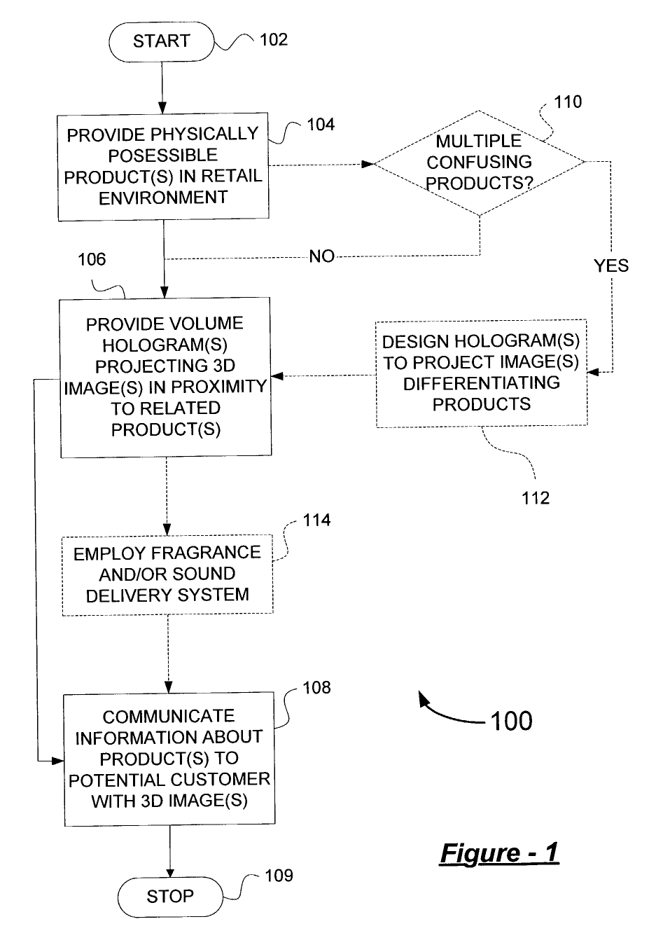

The present invention uses a true hologram, such as a “Zebra”, in proximity to a product in a retail environment to attract the attention of a potential customer and convey information about the product. According to various aspects of the invention, the 3D image generated by the true hologram is designed to communicate an appearance feature, a functional feature, an associated characteristic, and/or a method of use of the product. Examples of an appearance feature can be color of package, color of product, label design or shape of the package. Examples of a functional feature can be form (such as stick, cream or gel), low residue property, non-tacky property, flexible parts and smoothness upon application. Examples of an associated characteristic include fragrance, flavor, emotional state of user, sensorial experience, and environmental metaphors (for example, lightening for power). Examples of method of use include mixing of ingredients and demonstrating application of product. The 3D image is also designed to show and/or efficiently and effectively differentiate multiple, confusing products from one another in a retail environment. FIG. 1 illustrates the method 100 of the present invention, which includes three main steps.

Beginning at 102, method 100 proceeds to first main step 104, wherein a product is provided to a potential customer in a retail environment by placing the product in a storage structure from which it is possible for the customer to take physical possession of the product. Usually, this step corresponds to stocking a shelf or display case with the product, but can vary significantly from product to product and retail environment to retail environment. The storage structure can be a double sided shelf (with a collection of products on both sides), an endcap structure such as may be found at the end of a double sided shelf structure, a wall shelf or an island placed in an open space where consumers pass by.

From first main step 104, method 100 proceeds to second main step 106, wherein a true hologram is provided that generates a 3D holographic image into a space proximate to the product (for example, at a distance of no more than 5 meters from the storage structure, preferably no more than 3 meters from the storage structure, and especially within 1 meter from the storage structure). Preferably, the 3D image is viewable from a location in the retail environment that accommodates customer traffic flow so as to be readily viewable by the potential customer. With a hologram plate, this step usually entails placing the hologram plate in a position proximate to the product and orienting it in a direction facing customer traffic.

From second main step 106, method 100 proceeds to third main step 108, wherein information about the product is communicated to the potential customer via the generated 3D image. This step essentially entails designing the true hologram ahead of time to generate a 3D image that communicates information about the product. According to one aspect of the present invention, information communicated about the product relates to specific information, for example, a functional feature and/or associated characteristic of the product. For example, displaying a 3D image of a toothbrush flexing at a particular point in a specific direction with a given range communicates a functional feature of the product. Further, displaying an image of nature in spring to communicate that a detergent has a spring scent communicates an associated characteristic that the product possesses. Thus, a 3D visual image can serve as a metaphor for a non-visual characteristic of a product. The method 100 ends at 109. The method of the invention is preferably performed in a time frame of less than or equal to 60 seconds (more preferably not exceeding 30 seconds) and is based on the activities and maturity of a typical consumer over 18 years of age.

According to another aspect of the present invention, information communicated about the product serves to differentiate the featured product from one or more confusing or competing products, and additional, optional steps may be employed to enhance the present invention in relation to either and/or both of the aforementioned aspects. Therefore, method 100 contains at least one optional step. For example, and as at 110, if multiple confusing products are provided in step 104, and/or if other, confusing products already exist in the retail environment, then the method 100 may proceed from step 104 to step 112, wherein design of the true hologram is affected to differentiate the product from other, confusing or competing products. For example, antiperspirant packaging frequently uses similar shapes in a small variety of colors, wherein color designation is not clearly coded to the product. Accordingly, using one or more true holograms to distinguish among various forms and features of a selection of antiperspirants/deodorants is one potential use of the present invention. Thus, generating a 3D image from a true hologram in proximity to the corresponding product of a particular brand whereby the image demonstrates distinguishing features and/or characteristics of a residue-free antiperspirant stick can distinguish it from a nearby hypoallergenic antiperspirant stick of the same brand, and a nearby clear antiperspirant gel of the same brand. Further, the true holograms demonstrating features and/or characteristics of the other two products in proximity to the other two products further assists customers in immediately distinguishing between confusing products. This functional use of multiple 3D holographic images generated by true holograms designed to distinguish between confusing products near to one another in a retail environment is still further enhanced where the spatial configuration of the multiple holographic images reflects the spatial relation of the multiple and confusing products.

Another example of an optional step in method 100 is the use of some type of sensorial experience which is provided in conjunction with the true hologram and in close proximity thereto. For example, fragrance and/or sound delivery systems at step 114 that are placed in proximity to the product and/or 3D image to assist in communicating the information. Further examples include: (1) A 3D image of nature in spring to communicate that a detergent or cleaning product has a spring scent can be supplemented with a sample of the spring scent present in the product using a fragrance delivery system that is either passive (scent sprayed at regular intervals) or active (motion activated (for example with an electronic sensor) and/or intentionally activated by a customer by pressing a button). (2) The conveyed spring fragrance experience can be further supplemented by the sound of birdsong delivered either passively or actively. (3) Cooling effect of an underarm product can be reinforced by a burst of cold air with or without fragrance. (4) The creamy feel of a body lotion can be emphasized by having a hand activated pump dispenser with test product available.

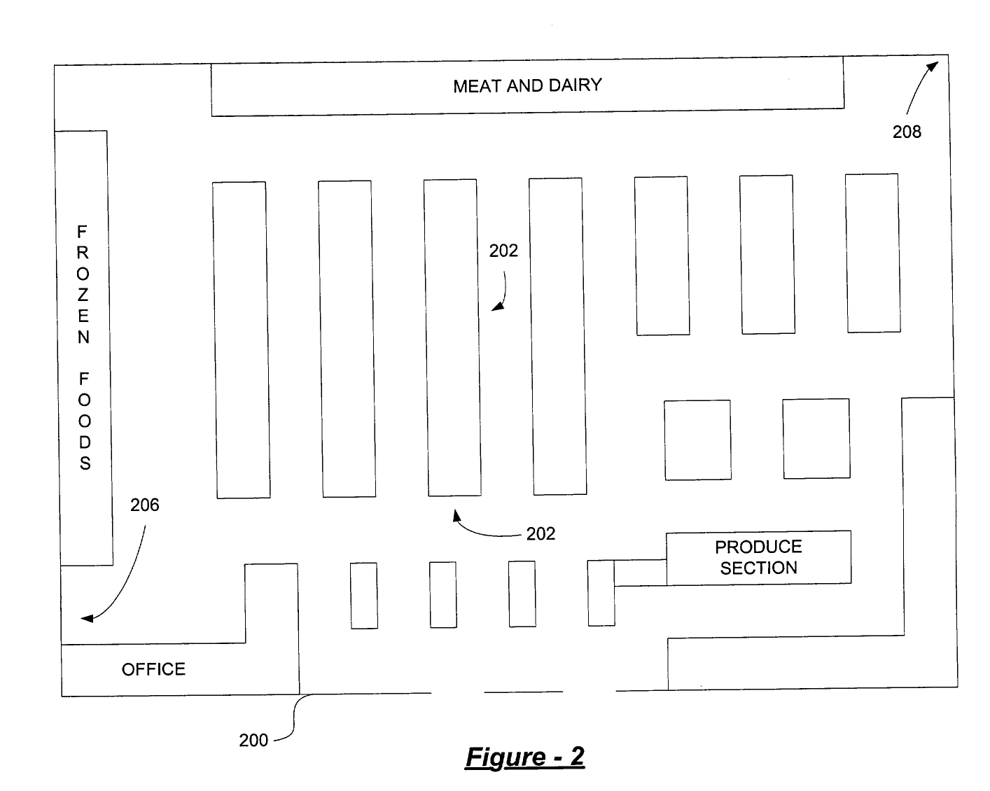

FIG. 2 shows a layout of an example retail environment in which the present invention may be employed. Floor plan 200 corresponds to the layout of an example grocery store, wherein customers shop various aisles and/or other designated customer traffic areas before exiting through a checkout area. These aisles and other traffic areas are generally bounded by storage structures such as shelves and/or display tables, racks, and/or floor area. Customers can take physical possession of products as they travel through designated traffic areas of the retail environment. Accordingly, the present invention may be used in various locations throughout the retail environment, and examples of candidate locations include in an aisle as at 202, near the end of an aisle as at 204, along a wall as at 206, in a corner as at 208, and also on or near the floor or ceiling below or above a customer traffic area. Notably, the invention may also be used at the entrance of a retail environment as well as outside of a structure enclosing a majority of the retail environment.

This invention also includes the use of one or more additional true holograms. Such holograms may be used together, wherein a second volume hologram located in an area of the retail environment remote from the first hologram leads a customer to a first true hologram located in proximity to the product. For example, where a first 3D holographic image communicating features and/or characteristics of a first product is generated in proximity to the first product in a retail environment, a second true hologram communicating features and/or characteristics of the first product may also be used to generate a 3D holographic image into a space proximate to a second product. This technique is especially powerful where the features and/or characteristics of the first product make it desirable for use with the second product. Thus, generating a holographic image depicting no or low white residue antiperspirant next to black clothing in a department store may be combined with generating substantially the same holographic image in proximity to the actual no or low white residue antiperspirant product at a point of sale in the same store. A second use of this technique which is very powerful is where the features and or characteristics of both products are similar. Thus, using a true hologram to depict hypoallergenic features of an antiperspirant next to an area where hypoallergenic dishwashing detergents are found in combination with generating the same hologram in proximity to the hypoallergenic antiperspirant itself in the same retail environment aids the consumer who is looking for skin-sensitive products. A third example is the positioning of a second or multiple true holograms at other areas in a retail environment to attract the consumer's attention. Such placements may include the entrance of the store, a snack bar, or a restroom. While the use of multiple holograms may be with images that are the same or different, it is likely that consistency of image will be preferred. Thus, the multiple images should be substantially the same or have enough similarity as to reinforce the product identity. Of note, using the same hologram further assists in leading the customer to the non-marking antiperspirant where the visual association is established at the point of need and exploited at the point of sale.

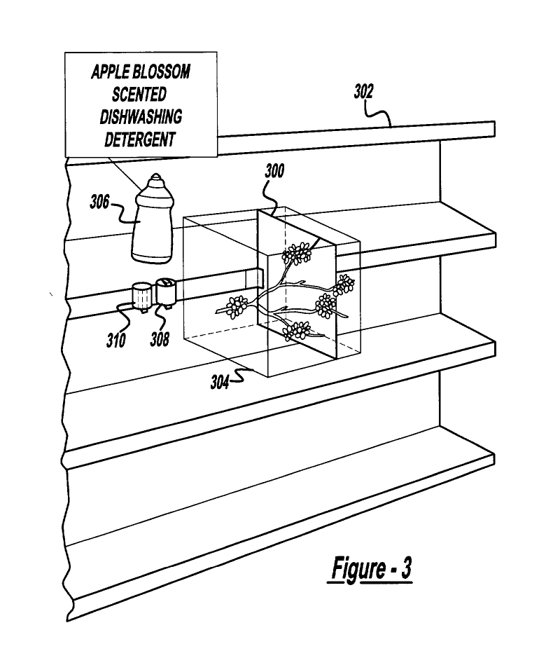

FIG. 3 demonstrates implementation of a true hologram 300 attached to a storage structure 302 and generating a 3D holographic image into an image space 304 proximate to a related product 306. In the illustrated case, the true hologram 300 is recorded in a double-sided hologram plate, the storage structure 302 corresponds to a shelf bounding an aisle, the 3D image corresponds to apple blossoms, and the product 306 corresponds to apple blossom scented dishwashing detergent.

As demonstrated, the construction and configuration of the hologram plate(s), other holographic recording media, and/or other holographic surface(s) used to provide the 3D holographic images from true hologram(s) may vary to accommodate the particular traffic flow at the chosen location and/or placement of the product at the chosen location. The double sided hologram plate proves advantageous in the illustrated case because it allows the 3D image to be viewed by traffic approaching from either direction along the aisle without restricting customer access to shelf space. Each side of the plate can project the same 3D image (from different viewpoints) into the same image space 304 in front of the related product 306, thereby attracting the customer's attention and directing the customer to the related product. According to the illustrated case, the 3D image is designed to bisect the image plane(s) (the holographic surface(s)) of the image space as viewed from either direction, but could alternatively be placed entirely behind the image plane as viewed from the right, while entirely in front of the image plane as viewed from the left. The implementation further employs a motion activated fragrance delivery system 308 and a motion activated sound delivery system 308, and these systems are strategically placed to respectively deliver apple blossom scent and sounds of bird song when a customer moves into an advantageous position for simultaneously viewing the related product 306 and the 3D image.

Fragrance delivery systems for use with the present invention may be selected from a variety of types of devices either commercially available or custom made to fit the appropriate space. For example, such a device may be constructed, if not otherwise commercially available, using a housing enclosing a pressure chamber. Pressure is produced in the filled pressure chamber using an electrically-activated piezoelectric actuator disposed in a plate forming a side of the pressure chamber. A motion detector is attached to the housing and oriented in a frontal direction selected to detect motion of proximate foot traffic. An attachment mechanism is disposed in a rear portion of the housing and oriented to facilitate attachment of the housing to a storage structure. A one-way fill aperture permits filling of the pressure chamber with fragrance solution from a reservoir of fragrance solution. A battery powers the motion detector and, when motion is detected via the motion detector, an electric signal is produced and communicated to the piezoelectric actuator. The electric signal creates an electric potential difference in the piezoelectric actuator such that pressure increases in the pressure chamber. When the pressure increases, fragrance solution exits a nozzle that is formed in the housing and oriented to dispense fragrance solution in a forward direction. The motion detector is adapted to cease production of the electric signal after a predetermined amount of time, and the fill reservoir is adapted to refill the pressure chamber with fragrance solution in response to the reduced pressure.

Sound delivery systems for use with the present invention may be selected from a variety of types of devices either commercially available or custom made to fit the appropriate space. For example, such a device may be constructed, if not otherwise commercially available, using a housing enclosing a sound module in communication with a speaker and a recording medium. A motion detector is attached to the housing and oriented in a frontal direction selected to detect motion of proximate foot traffic. An attachment mechanism is disposed in a rear portion of the housing and oriented to facilitate attachment of the housing to a storage structure. A battery powers the motion detector and the sound module and, when motion is detected via the motion detector, an electric signal is produced and communicated to the sound module. In response to the electric signal, a sound recorded on the recording medium is generated by the sound module via the speaker. Apertures formed in the front of the housing facilitate communication of the generated sound to passing foot traffic.

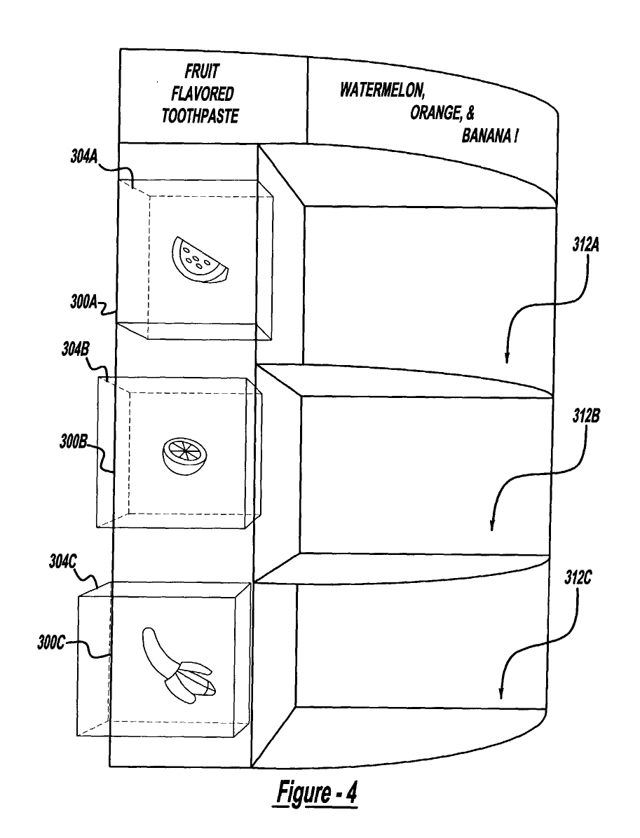

FIG. 4 demonstrates implementation of a multiplicity of true holograms 300A, 300B, and 300C incorporated into a storage structure 302 and projecting 3D holographic images into spaces 304A, 304B, and 304C which spaces are in proximity to product space 312A, 312B, and 312C for storing products. In the illustrated case, the true holograms 300A, 300B, and 300C are recorded on single-sided hologram plates, the storage structure 302 corresponds to a modular display for strategic placement in a corner, at an end of an aisle, and/or along a wall, and the 3D holographic images in spaces 304A, 304B, and 304C respectively correspond to watermelon, orange, and banana. The products to be stored in product spaces 312A, 312B, and 312C in the illustrated case match with corresponding types of fruit flavored toothpaste. 3D Holographic images in spaces 304A, 304B, and 304C illustrate that the generated 3D image can be displayed behind the image plane as with 304A, bisecting the image plane as with 304B, or in front of the image plane as with 304C. These images also illustrate how multiple images can be selected to distinguish between multiple, confusing products that are placed in proximity to one another.

From the foregoing description, it can be extrapolated that aspects of the present invention can be expanded and combined in a number of ways. For example, the true hologram of FIG. 3 could be made single-sided so as to be viewable from only one direction. Also, the case of FIG. 4 illustrates that the generated 3D images can be designed to communicate an appearance feature, a functional characteristic, an associated characteristic and/or a method of use of a product while simultaneously differentiating between confusing or competing products based on differences between them. It may therefore be extrapolated that the images can be designed to communicate specific functional features of products while simultaneously differentiating between the products based on differences between the functional features. Further, more than two hologram plates may be combined to project the same image, and hologram plates may also be incorporated into individual product packaging. Still further, the use of hologram plates throughout the disclosure to provide the 3D holographic images is only a presently preferred embodiment in view of current technology and market forces. It is therefore foreseeable that the present invention may be equivalently implemented with other holographic surfaces, including active displays. The method of the invention further includes the use of more than two true holograms to generate a holographic image for each hologram wherein (a) at least one holographic image is projected into said first space, (b) the remaining holographic images may be alike or different from the holographic image projected into said first space, and (c) the remaining holographic images may be projected into spaces remote from said first space.

In an alternate embodiment, the holographic plate can be in the form off a polymeric film placed on the floor in proximity to the product so that the holographic image appears to rise from the floor. Reference is made to technology from Zebra Imaging for such equipment.

It should also be noted that the image generated may be the same, larger or smaller than the true size of the object to be featured.

Moreover, the description of the invention is merely exemplary in nature and, thus, variations that do not depart from the gist of the invention are intended to be within the scope of the invention.

What is claimed is:

1. A method of increasing likelihood of a sale of a product in a retail environment comprising the steps of:
providing said product in a storage structure from which a potential purchaser may take physical possession of the product;
using a true hologram to generate a three-dimensional holographic image in a first space proximate to said storage structure to attract potential purchaser attention; and
using the holographic image to communicate information about said product to the potential purchaser.

2. The method of claim 1, wherein said information includes at least one member selected from the group consisting of:
(a) an appearance feature of the product;
(b) a functional feature of the product;
(c) an associated characteristic of the product; and
(d) an instruction on how to use the product.

3. The method of claim 1, wherein the information is communicated within a time period of 60 seconds.

4. The method of claim 1 wherein the holographic image is within 5 meters of the storage structure.

5. The method of claim 1 wherein the holographic image is within 3 meters of the storage structure.

6. The method of claim 1 wherein the holographic image is within 1 meter of the storage structure.

7. The method of claim 1 wherein said storage structure is positioned adjacent a shopping aisle and wherein the holographic image of said product is generated at least partially into said shopping aisle.

8. The method of claim 1 wherein the storage structure is selected from the group consisting of (a) a double sided shelf, (b) an endcap of an aisle, and (c) an island display.

9. The method of claim 1 wherein the storage structure and the hologram are positioned on a display that is positioned against a wall.

10. The method of claim 1 wherein said first space is selected from the group consisting of (a) a space above said storage structure and (b) a space coming up from the floor of an aisle in front of said storage structure.

11. The method of claim 1 wherein said information about said appearance feature of the product; said functional feature of the product; said associated characteristic of the product; or said instruction on how to use the product is communicated to said potential purchaser in response to changes in said potential purchaser's vantage point relative to said first space.

12. The method of claim 11 wherein a visual experience is interactively communicated to said potential purchaser in response to changes in said potential purchaser's vantage point relative to said first space that are effected voluntarily by said potential purchaser.

13. The method of claim 1 wherein said information communicating step is substantially performed in less than 30 seconds.

14. The method of claim 1 wherein said holographic image of the product that is larger or smaller than the real life size of the product.

15. The method of claim 1 wherein said holographic image of the product that is as large as the real life size of the product.

16. The method of claim 1 wherein said information communicating step is performed by associating at least one associated characteristic with an olfactory experience and employing a fragrance delivery system proximate to said storage structure to deliver a predetermined fragrance into a volume proximate to said first space.

17. The method of claim 16 wherein said fragrance delivery system is a passive system that delivers said predetermined fragrance into said volume on a predetermined basis.

18. The method of claim 16 wherein said fragrance delivery system is an active system that delivers said predetermined fragrance in response to a sensed physical presence of said potential purchaser.

19. The method of claim 1 wherein said information communicating step is performed by:
(a) associating with an auditory experience at least one said appearance feature of the product; or one said functional feature of the product; or one said associated characteristic of the product; or one instruction on how to use the product; and
(b) employing a sound delivery system proximate to said storage structure to deliver a predetermined auditory information into a volume proximate to said first space.

20. The method of claim 19 wherein said sound delivery system is a passive system that delivers said predetermined auditory information into said volume on a predetermined basis.

21. The method of claim 19 wherein said sound delivery system is an active system that delivers said predetermined auditory information in response to a sensed physical presence of said potential purchaser.

22. The method of claim 1 wherein said information communicating step is performed by associating at least one said appearance feature of the product; or one said functional feature of the product; or one said associated characteristic of the product; or one instruction on how to use the product with at least one of:
(a) an olfactory experience which employs a fragrance delivery system proximate to said storage structure to deliver a predetermined fragrance into a volume proximate to said first space; and
(b) an auditory experience which employs a sound delivery system proximate to said storage structure to deliver a predetermined auditory information into a volume proximate to said three-dimensional space.

23. The method of claim 1 comprising:
(a) providing a second true hologram to generate a second three-dimensional holographic image into a second space proximate to said product or proximate to a second product in the retail environment; and
(b) using the second holographic image to communicate information about said product and said second product to the potential purchaser.

24. The method of claim 23 wherein the information includes at least one member selected from the group consisting of:
(a) an appearance feature of the product;
(b) a functional feature of the product;
(c) an associated characteristic of the product; and
(d) an instruction on how to use the product that renders the product desirable for use with the second product.

25. The method of claim 23 wherein the product and the second product have a similarity corresponding to at least one functional feature or associated characteristic, and wherein the second holographic image is designed to communicate said similarity to the potential customer.

26. The method of claim 23 wherein the holographic image and the second holographic image are substantially identical, thereby creating a visual association at a point of need that assists in leading the potential customer to the holographic image in said first space proximate to the product at a point of sale.

27. The method of claim 1 comprising:
providing a second true hologram to project a second holographic image into a second space in the retail environment at a point not proximate to said product;
using the second holographic image to communicate information about said product to the potential purchaser,
wherein the holographic image and the second holographic image are substantially identical, thereby creating a visual association assisting in leading the potential customer to the holographic image proximate to the product at a point of sale.

28. A method of assisting a potential purchaser in making a selection among a plurality of related products in a retail environment comprising the steps of:
providing said plurality of related products in a storage structure from which a potential purchaser may take physical possession of a selected product;
providing a true hologram to project a three dimensional holographic image into a first space proximate to said storage structure to attract potential purchaser attention; and
using said holographic image to communicate information about differences among said plurality of related products to the potential purchaser.

29. The method of claim 28 further comprising using said holographic image to communicate information about distinguishing features among said plurality of related products to said potential purchaser.

30. The method of claim 28 further comprising:
organizing said plurality of related products into groups according to at least one distinguishing feature; and
communicating information about differences among said groups by generating a plurality of different holographic images, wherein at least one of said plural different images corresponds to each of said groups.

31. The method of claim 28 further comprising:
(a) arranging said plurality of related products into physically separate groups according to at least one distinguishing feature; and
(b) communicating information about differences among said groups by generating a plurality of different holographic images, such that at least one of said plural different images corresponds to one of each of said groups and is projected into an associated space proximate to its corresponding group.

32. The method of claim 1 further comprising the use of more than two true holograms to generate a holographic image for each hologram wherein (a) at least one holographic image is projected into said first space, (b) the remaining holographic images may be alike or different from the holographic image projected into said first space, and (c) the remaining holographic images may be projected into spaces remote from said first space.
